(19) United States
(12) Patent Application Publication
(10) Pub. No.: US 2023/0318012 A1
(43) Pub. Date: Oct. 5, 2023

(54) CYLINDRICAL BATTERY AND BATTERY MODULE

(71) Applicant: HONDA MOTOR CO., LTD., Tokyo (JP)

(72) Inventor: Toshiyuki ARIGA, Saitama (JP)

(21) Appl. No.: 18/166,485

(22) Filed: Feb. 9, 2023

(30) Foreign Application Priority Data
Mar. 29, 2022 (JP) 2022-054485

(51) Int. Cl. H01M 10/04; H01M 10/0587

(52) U.S. Cl. CPC H01M 10/0422; H01M 10/0587

(57) ABSTRACT

Provided is a cylindrical battery including: a shaft member; a wound electrode group in which an electrode laminate of a positive electrode and a negative electrode laminated via an electrolyte is wound around the shaft member; a fixing member that fixes an end of the wound electrode group on a side not in contact with the shaft member in a winding direction; and an exterior member that winds around the wound electrode group and the fixing member, one end of the fixing member in the winding direction overlapping with the wound electrode group, and the other end in the winding direction overlapping with the exterior member.

This application is based on and claims the benefit of priority from Japanese Patent Application No. 2022-054485, filed on 29 Mar. 2022, the content of which is incorporated herein by reference.

### BACKGROUND OF THE INVENTION

### Field of the Invention

The present invention relates to a cylindrical battery and a battery module.

### Related Art

In recent years, research and development of secondary batteries that contribute to energy efficiency have been carried out to ensure access to affordable, reliable, sustainable, and advanced energy for many people.

Patent Document 1 discloses a nonaqueous electrolyte secondary battery including a cylindrical-shaped battery outer can, and a rolled electrode assembly formed by rolling a positive electrode plate and a negative electrode plate with a separator interposed therebetween to insulate each other, the positive electrode plate being formed by applying a positive electrode active material mixture to both sides of a positive electrode core body, and the negative electrode plate being formed by applying a negative electrode active material mixture to both sides of a negative electrode core body, and the rolled electrode assembly being contained in the battery outer can. The separator is disposed on the outermost periphery of the rolled electrode assembly, and the separator is fixed to the outermost periphery of the rolled electrode assembly with a tape for fixing a roll end. Moreover, the negative electrode core body, in which a negative electrode active material mixture layer is not formed, is disposed on the outermost periphery side of the negative electrode plate, and a negative electrode tab is connected to the negative electrode core body on the outermost periphery side. Further, the tape for fixing a roll end does not overlap with the roll end of the positive electrode plate, and the roll end of the negative electrode core body.
Patent Document 1: Japanese Unexamined Patent Application, Publication No. 2010-212086

### SUMMARY OF THE INVENTION

In all-solid secondary batteries, in order to reduce the interface resistance of a solid electrolyte layer and electrodes, an electrode laminate of a positive electrode and a negative electrode laminated via the solid electrolyte layer is pressed when winding the electrode laminate to produce a wound electrode group. In order to press the electrode laminate uniformly, it is desirable to reduce level difference in the winding direction of the wound electrode group.

An object of the present invention is to provide a cylindrical battery that can reduce level difference in the winding direction of a wound electrode group.

One embodiment of the present invention is a cylindrical battery including: a shaft member; a wound electrode group in which an electrode laminate of a positive electrode and a negative electrode laminated via an electrolyte is wound around the shaft member; a fixing member that fixes an end of the wound electrode group on a side not in contact with the shaft member in a winding direction; and an exterior member that winds around the wound electrode group and the fixing member, one end of the fixing member in the winding direction overlapping with the wound electrode group, and the other end in the winding direction overlapping with the exterior member.

The fixing member is an insulator, and the length of the fixing member in an axial direction of the shaft member may be larger than the length of the wound electrode group in the axial direction of the shaft member.

The fixing member is a double-sided tape, and one side of the double-sided tape may fix the wound electrode group, and the other side may fix the exterior member.

In the fixing member, an inclination may be formed, in which the fixing member has a larger thickness on the wound electrode group side than on the exterior member side in a region between the wound electrode group and the exterior member in the winding direction.

The thickness of the exterior member may be smaller than the thickness of the electrode laminate.

The thickness of the exterior member may be larger than a thickness obtained by subtracting the thickness of the positive electrode or the negative electrode from the thickness of the electrode laminate.

In the electrode laminate, the positive electrode and the negative electrode may be laminated via a solid electrolyte layer.

Another embodiment of the present invention is a battery module including a plurality of the cylindrical batteries.

According to the present invention, a cylindrical battery that can reduce level difference in the winding direction of a wound electrode group can be provided.

### BRIEF DESCRIPTION OF THE DRAWINGS

FIG. 1 is a partially cutaway perspective cross-sectional view showing an example of the battery module of the present embodiment;

FIG. 2 is a cross-sectional view showing the cylindrical battery of FIG. 1;

FIGS. 3A and 3B are cross-sectional views showing the cylindrical battery of FIG. 1; and

FIG. 4 is a side view showing the state of the cylindrical battery of FIG. 1 before being wound with an exterior member.

### DETAILED DESCRIPTION OF THE INVENTION

An embodiment of the present invention will be described below with reference to the drawings.

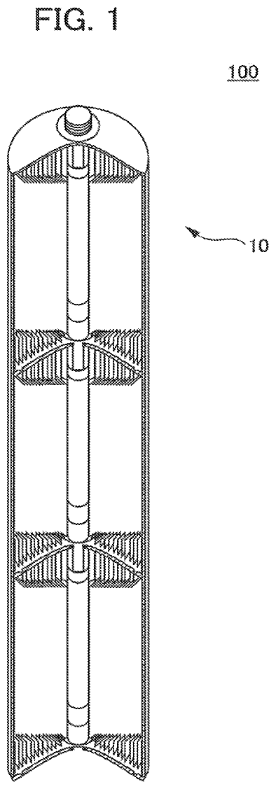

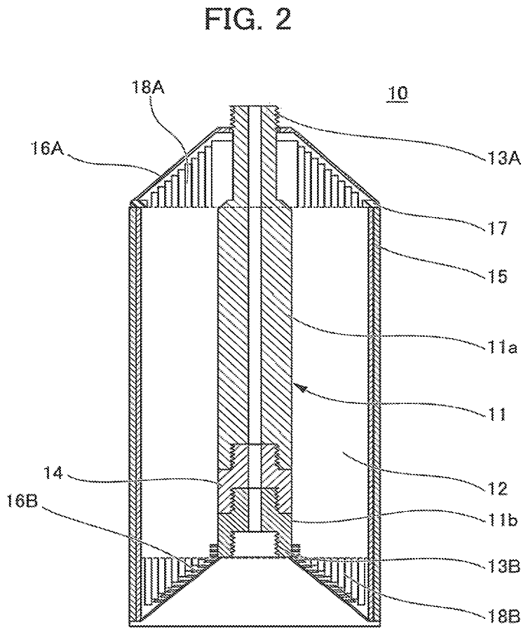

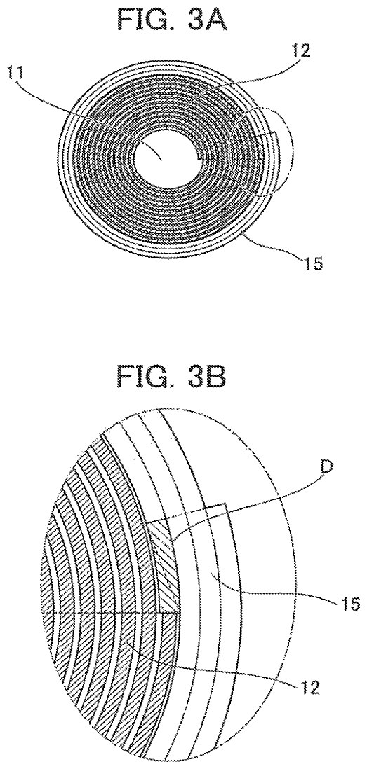

FIG. 1 shows an example of the battery module of the present embodiment. FIGS. 2, 3A, and 3B show the cylindrical battery of FIG. 1. FIG. 3B is a partially enlarged view of the area surrounded by the dashed line in FIG. 3A.

A battery module 100 includes a plurality of cylindrical batteries 10. Each cylindrical battery 10 has a shaft member 11, a wound electrode group 12 in which an electrode laminate of a positive electrode and a negative electrode laminated via an electrolyte is wound around the shaft member, a male thread 13A as a first fastener provided at one (upper) end of the shaft member 11 in the axial direction, and a female thread 13B as a second fastener provided at the other (lower) end of the shaft member 11 in the axial direction. In the battery module 100, the adjacent cylindrical batteries 10 are connected through the male thread 13A and the female thread 13B.

In this case, the male thread 13A is integrally molded with the shaft member 11. Therefore, the strength against rotational torque is increased when fastening the male thread 13A and the female thread 13B. The male thread 13A is electrically connected to one of the positive electrode and negative electrode, and the female thread 13B is electrically connected to the other of the positive electrode and the negative electrode.

The first fastener may be a female thread, and the second fastener may be a male thread.

The shaft member 11 is provided with an insulating member 14 in the axial direction between a first conductive member 11a and a second conductive member 11b, and the insulating member 14 is fastened with the first conductive member 11a and the second conductive member 11b. Due to this, an insulating member 17, described later, is compressed, thereby improving the sealability of the cylindrical battery 10. The first conductive member 11a is provided with a female thread at the lower end in the axial direction. The insulating member 14 is provided with a male thread at the upper end in the axial direction, and a female thread at the lower end in the axial direction. Further, the second conductive member 11b is provided with a male thread at the upper end in the axial direction.

The materials that constitute the first conductive member 11a and the second conductive member 11b are not particularly limited, and examples include metal and the like. The material that constitutes the insulating member 14 is not particularly limited, and examples include polypropylene (PP), polyethylene (PE), polyethylene terephthalate (PET), polyphenylene sulfide (PPS), polytetrafluoroethylene (PTFE), PFA, and other resins.

The electrode laminate has a sheet-like shape, and each electrode has an electrode mixture layer formed on an electrode current collector. That is, the positive electrode has a positive electrode mixture layer formed on a positive electrode current collector, and the negative electrode has a negative electrode mixture layer formed on a negative electrode current collector. The electrolyte is not particularly limited, and may be contained in, for example, an electrolytic solution impregnated in a general resin porous membrane (separator), a gel electrolyte layer, a solid electrolyte layer, or the like.

It is sufficient for the electrode laminate that a positive electrode and a negative electrode are laminated via an electrolyte. The electrode laminate may have a plurality of positive electrodes and/or negative electrodes. The laminated structure of the electrode laminate having a plurality of positive electrodes and/or negative electrodes is, for example, positive electrode/electrolyte/negative electrode/electrolyte/positive electrode. In this case, the electrode laminate can be produced, for example, by roll-pressing.

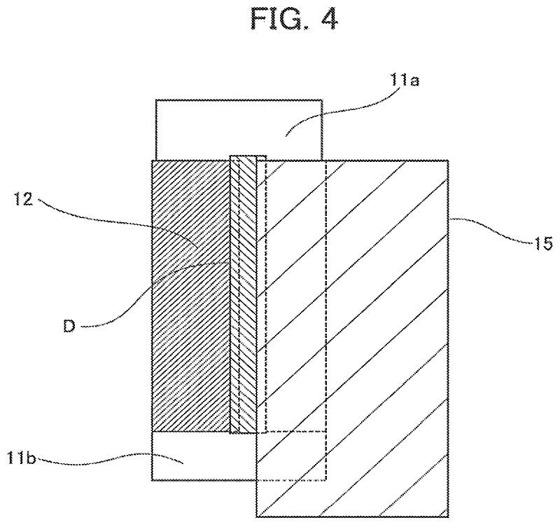

The cylindrical battery 10 further has a double-sided tape D as a fixing member that fixes the end of the wound electrode group 12 on the side not in contact with the shaft member 11 in the winding direction, and an exterior member 15 that winds around the wound electrode group 12 and the double-sided tape D. In this case, one side of the double-sided tape D fixes the wound electrode group 12, and the other side fixes the exterior member 15. Further, one end of the double-sided tape D in the winding direction of the wound electrode group 12 overlaps with the wound electrode group 12, and the other end in the winding direction of the wound electrode group 12 overlaps with the exterior member 15 (see FIG. 4). Therefore, level difference in the winding direction of the wound electrode group 12 is reduced in the cylindrical battery 10. FIG. 4 shows the state of the cylindrical battery 10 before being wound with the exterior member 15, and illustration of an extender 18A and an extender 18B, described later, is omitted for the convenience of explanation. The length of the double-sided tape D in the axial direction of the shaft member 11 is larger than the length of the wound electrode group 12 in the axial direction of the shaft member 11. In this case, the double-sided tape D, which is an insulator, ensures the insulation of the wound electrode group 12 and exterior member 15.

The length of the double-sided tape D in the winding direction of the wound electrode group 12 is not particularly limited, and is, for example, equal to or more than 3 times the thickness of the electrode laminate to be fixed (the sum of the thicknesses of the positive electrode, electrolyte, and negative electrode) and ½ or less of the circumference of the wound electrode group 12, and is preferably 10% or more and 30% or less of the circumference of the wound electrode group 12. The thickness of the double-sided tape D is not particularly limited, and is, for example, 5 μm or more and 10 μm or less.

The wound electrode group 12 wound with the exterior member 15 is obtained by winding the electrode laminate and the exterior member 15 around the shaft member 11 while applying a predetermined tension. In this case, the electrode laminate and the exterior member 15 may be wound while pressing from the outside of the shaft member 11. Due to this, the double-sided tape D is compressed, and in the region between the wound electrode group 12 and the exterior member 15 in the winding direction of the wound electrode group 12, an inclination in which a thickness on the wound electrode group 12 side is larger than a thickness on the exterior member 15 side (see the dashed line in FIG. 3B) is formed. As a result, level difference in the winding direction of the wound electrode group 12 is reduced in the cylindrical battery 10. The inclination may be an inclined plane or an inclined curved surface.

The fixing member is not limited to the double-sided tape D, and may be a pressure-sensitive adhesive, for example. Further, a step may be provided in the fixing member, and the exterior member 15 may be wound from the step provided in the fixing member.

The exterior member 15 has a sheet-like shape. The material that constitutes the exterior member 15 is not particularly limited as long as it has conductivity, and examples include metal and the like.

Since the thickness of the exterior member 15 is smaller than the thickness of the electrode laminate, the gap between the wound electrode group 12 and the exterior member 15 is reduced, and the wound electrode group 12 can be easily held by the exterior member 15. Further, since the thickness of the exterior member 15 is larger than a thickness obtained by subtracting the thickness of the positive electrode or the negative electrode from the thickness of the electrode laminate, level difference in the winding direction of the wound electrode group 12 is reduced in the cylindrical battery 10.

The thickness of the exterior member 15 is not particularly limited, and is, for example, 100 μm or more and 300 μm or less. On the other hand, the thickness of the electrode laminate is not particularly limited, and is, for example, 110 μm or more and 310 μm or less. The thickness of the positive electrode is not particularly limited, and is, for example, 50 μm or more and 150 μm or less. Further, the thickness of the negative electrode is not particularly limited, and is, for example, 60 μm or more and 160 μm or less.

The cylindrical battery 10 further has a first lid member 16A disposed at one (upper) end in the axial direction and electrically connected to one of the positive electrode and negative electrode, and a second lid member 16B disposed at the other (lower) end in the axial direction and electrically connected to the other of the positive electrode and the negative electrode. The first lid member 16A and the second lid member 16B each have an inclined region that is substantially symmetrically inclined with respect to the shaft member 11, and have a conical outer shape. Further, a ring-shaped insulating member 17 is disposed between the exterior member 15 and the first lid member 16A. On the other hand, the first lid member 16A is electrically connected to the male thread 13A, and the second lid member 16B is electrically connected to the female thread 13B and the exterior member 15.

The inclination angle of the inclined region in the first lid member 16A and second lid member 16B with respect to the shaft member 11 is not particularly limited. The inclination angle of the inclined region in the first lid member 16A with respect to the shaft member 11 is made by the height of an extender 18A adjacent to the wound electrode group 12 on the side of the shaft member 11, and the width determined by the number of turns of the wound electrode group 12. The inclined region of the first lid member 16A has a capacity enough to contain the extender 18A.

The materials that constitute the first lid member 16A and the second lid member 16B are not particularly limited as long as they have conductivity, and examples include metal and the like. The materials that constitute the first lid member 16A and the second lid member 16B may be the same or different.

The insulating member 17 is compressed by the fastening force that fastens the male thread 13A provided at the upper end of the shaft member 11 in the axial direction, and the female thread 13B provided at the lower end of the shaft member 11 in the axial direction. As a result, the exterior member 15 and the first lid member 16A are fixed to achieve sealing. On the other hand, the contact part of the second lid member 16B with the exterior member 15 is joined by laser welding to achieve sealing and integration.

The material that constitutes the insulating member 17 is not particularly limited, and examples include polypropylene (PP), polyethylene (PE), polyethylene terephthalate (PET), polyphenylene sulfide (PPS), polytetrafluoroethylene (PTFE), PFA, and other resins.

The positive electrode current collector has an extender 18A extending from one (upper) end of the wound electrode group 12 in the axial direction, and the negative electrode current collector has an extender 18B extending from the other (lower) end of the wound electrode group 12 in the axial direction. The extender 18A of the positive electrode current collector collects current in the first lid member 16A, and the extender 18B of the negative electrode current collector collects current in the second lid member 16B.

In this case, the second lid member 16B electrically connected to the extender 18B that collects current in the exterior member 15 has a larger inclination angle of the inclined region than the first lid member 16A electrically connected to the extender 18A that collects current in the shaft member 11. This makes it easy to connect the adjacent cylindrical batteries 10 through the male thread 13A and female thread 13B.

The following describes a case in which the cylindrical batteries that constitute the battery module of the present embodiment are all-solid lithium secondary batteries.

The positive electrode current collector is not particularly limited, and examples include aluminum foil and the like.

The positive electrode mixture layer contains a positive electrode active material, and may further contain a solid electrolyte, a conductive aid, a binder, and the like.

The positive electrode active material is not particularly limited as long as it can absorb and release lithium ions, and examples include LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, sulfur, and the like.

The solid electrolyte that constitutes the solid electrolyte layer is not particularly limited as long as it is a material that can conduct lithium ions, and examples include oxide-based electrolytes, sulfide-based electrolytes, and molecular crystal electrolytes in which an electrolyte dissociates to a crystal made of organic matter.

The negative electrode mixture layer contains a negative electrode active material, and may further contain a solid electrolyte, a conductive aid, a binder, and the like.

The negative electrode active material is not particularly limited as long as it can absorb and release lithium ions, and examples include metal lithium, lithium alloys, metal oxides, metal sulfides, metal nitrides, Si, SiO, carbon materials, and the like. Examples of carbon materials include artificial graphite, natural graphite, hard carbon, soft carbon, and the like.

The negative electrode current collector is not particularly limited, and examples include copper foil and the like.

The embodiment of the present invention has been described above; however, the present invention is not limited to the above embodiment. The embodiment may be modified, as appropriate, within the spirit of the present invention.

### EXPLANATION OF REFERENCE NUMERALS

10 Cylindrical battery
11 Shaft member
11a First conductive member
11b Second conductive member
12 Wound electrode group
13A Male thread
13B Female thread
14, 17 Insulating member
15 Exterior member
16A First lid member
16B Second lid member
18A, 18B Extender
100 Battery module
D Double-sided tape

What is claimed is:

1. A cylindrical battery comprising:
a shaft member;
a wound electrode group in which an electrode laminate of a positive electrode and a negative electrode laminated via an electrolyte is wound around the shaft member;
a fixing member that fixes an end of the wound electrode group on a side not in contact with the shaft member in a winding direction; and
an exterior member that winds around the wound electrode group and the fixing member,
one end of the fixing member in the winding direction overlapping with the wound electrode group,
the other end in the winding direction overlapping with the exterior member.

2. The cylindrical battery according to claim 1, wherein the fixing member is an insulator, and
a length of the fixing member in an axial direction of the shaft member is larger than a length of the wound electrode group in the axial direction of the shaft member.

3. The cylindrical battery according to claim 1, wherein the fixing member is a double-sided tape, and
one side of the double-sided tape fixes the wound electrode group, and the other side fixes the exterior member.

4. The cylindrical battery according to claim 1, wherein an inclination in which the fixing member has a larger thickness on the wound electrode group side than on the exterior member side is formed in a region between the wound electrode group and the exterior member in the winding direction.

5. The cylindrical battery according to claim 1, wherein the exterior member has a smaller thickness than the electrode laminate.

6. The cylindrical battery according to claim 5, wherein the exterior member has a thickness larger than a thickness obtained by subtracting a thickness of the positive electrode or the negative electrode from a thickness of the electrode laminate.

7. The cylindrical battery according to claim 1, wherein in the electrode laminate, the positive electrode and the negative electrode are laminated via a solid electrolyte layer.

8. A battery module comprising a plurality of the cylindrical batteries according to claim 1.
